(19) United States
(12) Patent Application Publication
(10) Pub. No.: US 2025/0159106 A1
(43) Pub. Date: May 15, 2025

(54) COLLABORATIVE OPERATING SYSTEM OF AUDIOVISUAL PERIPHERAL DEVICES AND OPERATING METHOD THEREOF

(71) Applicant: REALTEK SEMICONDUCTOR CORP., HSINCHU (TW)

(72) Inventor: KAI-HSIANG CHOU, HSINCHU (TW)

(21) Appl. No.: 18/945,795

(22) Filed: Nov. 13, 2024

(30) Foreign Application Priority Data
Nov. 15, 2023 (TW) 112143963

(51) Int. Cl. H04N 7/08; G06T 7/70; H04S 3/00; H04W 76/14

(52) U.S. Cl. CPC H04N 7/08; G06T 7/70; H04S 3/008; H04W 76/14; G06T 2207/10016; G06T 2207/30196

(57) ABSTRACT

A collaborative operating system of audiovisual peripheral devices and an operating method thereof are provided. The system provides an audiovisual console, which includes an audiovisual processing unit, and a microcontroller, at least one connection interface, and a data-processing unit that implement a collaborative operation of the audiovisual peripheral devices. The audiovisual console connects with the peripheral device via the connection interface based on a communication protocol, and obtains a permission for accessing a camera and a microphone that are detected. The audiovisual console receives a video and an audio from the peripheral device based on the communication protocol. After the data-processing unit processes the video and the audio, the microcontroller generates and provides audiovisual data to the audiovisual processing unit. Accordingly, a display displays the video, and a speaker plays the audio, thereby allowing the audiovisual console that has no camera and microphone to hold a video conference.

### CROSS-REFERENCE TO RELATED PATENT APPLICATION

This application claims the benefit of priority to Taiwan Patent Application No. 112143963, filed on Nov. 15, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system that incorporates a peripheral camera and an audio-receiving device, and more particularly to a collaborative operating system of audiovisual peripheral devices in which an audiovisual console uses audiovisual modules of its peripheral devices to achieve videoconferencing and an operating method thereof.

### BACKGROUND OF THE DISCLOSURE

Conventionally, a camera or a microphone is not installed in an audiovisual console (e.g., a television or a set-top box) due to costs or other considerations. The relevant considerations include, for example, no need for such peripherals in general applications or a low usage rate of the peripherals (since these peripherals are only needed for initialization in an early stage). Alternatively, a user of the audiovisual console may purchase the peripherals based on their own choice. Thus, other than few high-end models, the camera or the microphone is not pre-installed in most of the audiovisual consoles.

Without installation of the above-mentioned peripherals, the general models of the audiovisual consoles cannot expand to have more advanced functions. For example, the audiovisual console having the microphone can use the microphone to receive sounds from surround-sound speakers, and then perform calibration of positions of the speakers based on information of the sounds. Further, the audiovisual console may use the camera to capture images, and the images are further processed for determining placement positions of household items.

Therefore, when performing a specific application, the audiovisual console requires additional devices for assistance. For example, the audiovisual console needs to be connected with the camera and the microphone during a video conference. However, setting difficulties may arise due to cross-operating system issues.

In the related art, the audiovisual console includes a connection interface that is configured to expand peripheral devices. For example, the audiovisual console can expand its peripheral devices via a universal serial bus (USB). Nevertheless, even if the USB is used, scalability of the conventional audiovisual console still has much room for improvement due to poor driver compatibility.

### SUMMARY OF THE DISCLOSURE

In order to solve the problem that a traditional audiovisual console provided for processing audiovisual signals lacks video and audio peripheral devices, a collaborative operating system of audiovisual peripheral devices and an operating method thereof are provided for implementing a cross-platform solution to integrate the audiovisual peripheral devices. In this way, the audiovisual console can effectively use audiovisual functions of the audiovisual peripheral devices. For example, the audiovisual console achieves purposes such as audiovisual communications and videoconferencing. One of the aspects is to use a communication protocol of a video conference for communications between the audiovisual console and peripheral devices over different operating platforms.

In an aspect of the collaborative operating system of the audiovisual peripheral devices, an audiovisual console is provided. The audiovisual console includes an audiovisual processing unit used to process audiovisual data, a microcontroller used to operate collaboration of the audiovisual peripheral devices, at least one connection interface, and a data-processing unit used to process data transmitted via the at least one connection interface.

Further, in the operating method, the audiovisual console connects with at least one peripheral device via at least one connection interface based on a communication protocol, and detects one or more cameras and one or more microphones of the at least one peripheral device. After a permission for accessing the one or more cameras and the one or more microphones is obtained, the audiovisual console receives a video and an audio from the at least one peripheral device via the at least one connection interface based on the communication protocol. After data is processed by a data-processing unit, a microcontroller generates the audiovisual data to be provided to an audiovisual processing unit. After the audiovisual data is processed by the audiovisual processing unit, a display connected with the audiovisual console is used to display the video, and a speaker is used to play the audio.

Preferably, the audiovisual console and the at least one peripheral device are interconnected by a wireless local area network or a Bluetooth communication protocol when being located within a same local area network or a same area.

Preferably, when the audiovisual console and the at least one peripheral device are not located within the same local area network, a software program running an Interactive Connectivity Establishment (ICE) communication protocol or a Web Real-Time Communication (WebRTC) protocol is used to establish a connection between the audiovisual console and the at least one peripheral device.

Preferably, the at least one connection interface is a wireless or wired communication interface that is used to receive the video captured through lenses of the multiple cameras and the audio received by the multiple microphones of the at least one peripheral device.

Further, the multiple microphones form a microphone array, so as to receive the audio from the microphones at different positions and perform multi-channel beamforming for tracking a sound source. The microcontroller of the audiovisual console obtains information of a volume of each of the microphones, and performs positioning on the multiple microphones according to audio magnitude of each of the microphones. After the positioning of the multiple microphones is completed, positions, orientations, and gains of the multiple microphones are adjusted according to a location of a user.

Further, the microcontroller retrieves images captured through the lenses of the cameras, and an image-processing technology is used to compare the images of the video captured through each of the lenses, so as to determine a position of each of the cameras. Thus, in the audiovisual console, the location of the user can be determined by performing three-dimensional detection on the images captured through the lenses of the multiple cameras.

Still further, the user can use identification data to log in a server program of the audiovisual console and an audiovisual program of the at least one peripheral device, so that a connection is established between the audiovisual console and the at least one peripheral device, and the audiovisual console can obtain the permission for accessing the one or more cameras and the one or more microphones of the at least one peripheral device.

Further, the audiovisual console includes a regulation program that is used to regulate the video and the audio. The regulation program is used to determine the positions of the one or more microphones and the one or more cameras of the at least one peripheral device, determine a position of the speaker connected with the audiovisual console, regulate post-processing and a volume of the speaker, or regulate brightness and chrominance of a picture displayed on the display.

In an application, the audiovisual console and the at least one peripheral device form a first conference terminal, and the first conference terminal is configured to connect with a second conference terminal at the other side, so as to establish a conference session.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a system framework of a collaborative operating system of audiovisual peripheral devices according to one embodiment of the present disclosure;

FIG. 2 is a schematic diagram illustrating the collaborative operating system of the audiovisual peripheral devices according to one embodiment of the present disclosure;

FIG. 3 is a flowchart illustrating an operating method of the collaborative operating system of the audiovisual peripheral devices according to one embodiment of the present disclosure;

FIG. 4 is a schematic diagram illustrating a handshake process between an audiovisual console and a peripheral device according to one embodiment of the present disclosure;

FIG. 5 is a flowchart illustrating a process of establishing a conference session according to one embodiment of the present disclosure;

FIG. 6 is a flowchart illustrating a process of establishing a connection by a network address translation host according to one embodiment of the present disclosure;

FIG. 7 is a flowchart illustrating application of multiple audio channels of the collaborative operating system of the audiovisual peripheral devices according to one embodiment of the present disclosure; and

FIG. 8 is a flowchart illustrating application of multiple cameras of the collaborative operating system of the audiovisual peripheral devices according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a collaborative operating system of audiovisual peripheral devices and an operating method thereof. The method is a specific solution for allowing an audiovisual console (e.g., a set-top box or a television) having no audiovisual peripheral to utilize audiovisual functions provided by peripheral devices. In one aspect of the present disclosure, a specific communication protocol of a video conference is used for communications between an audiovisual console and the peripheral device(s) across different operating platforms. Therefore, the audiovisual console is capable of integrating various audiovisual peripheral devices across different cross-platforms. The method allows the audiovisual console to effectively use the audiovisual functions provided by the peripheral devices, so as to achieve purposes such as audiovisual communications and videoconferencing.

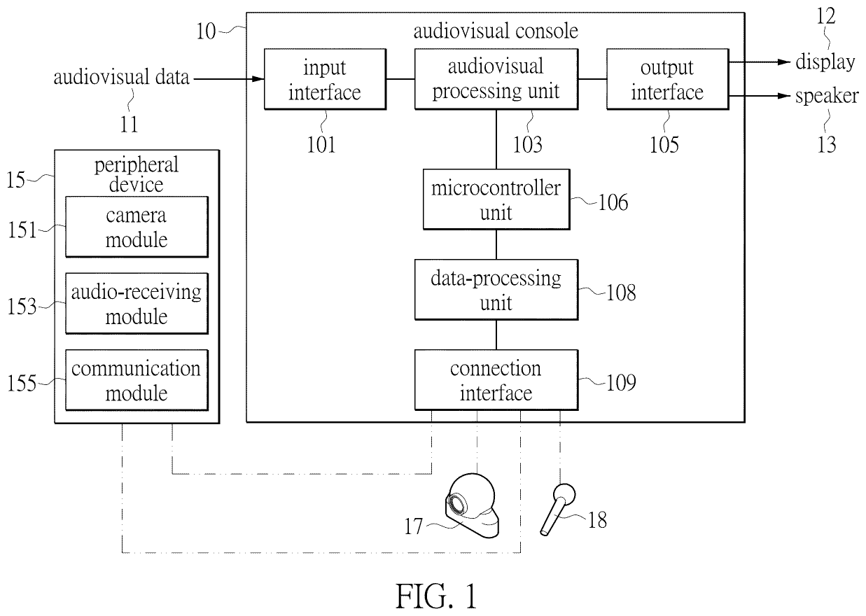

According to certain embodiments of the collaborative operating system of the audiovisual peripheral devices of the present disclosure, reference is made to FIG. 1, which is a schematic diagram illustrating a system framework of the collaborative operating system. The collaborative operating system includes an audiovisual console 10 (such as a set-top box) used to process audiovisual signals, an audiovisual processing module of a smart television, a computer system, or a specific audiovisual device. The audiovisual console 10 includes an audiovisual processing unit 103 that is originally used to process audiovisual data 11 and a relevant input/output circuit. The input/output circuit includes an input interface 101 used to receive the audiovisual data 11 and an output interface 105 used to output an audiovisual content to a display 12 and a speaker 13.

Further, the audiovisual console 10 includes an operating module that includes relevant processing circuits and software programs for processing data generated through collaboration of audiovisual peripherals. In the operating module, a microcontroller unit 106 is used to process various external signals and instructions. The microcontroller unit 106 is electrically connected with an audiovisual processing unit 103. The audiovisual processing unit 103 processes a video and an audio (e.g., video and audio encoding/decoding) from the microcontroller unit 106, and then outputs the video and the audio to the display 12 and the speaker 13 via the output interface 105.

The microcontroller unit 106 is used to control operations of the audiovisual console 10. For example, the microcontroller unit 106 provides the data to be received via a specific interface to the audiovisual processing unit 103. In an aspect of the audiovisual console 10, the audiovisual console 10 provides one or more connection interfaces 109 to connect with one or more external devices and a corresponding control circuit (such as a data-processing unit 108). The connection interface 109 can be various wired and wireless communication interfaces or connection terminals, such as a universal serial bus (USB), a Bluetooth™ communication interface, a wireless network (e.g., WiFi™) interface, or an industry-standard interface (e.g., a microphone connector). However, in practical application, the connection interface 109 is not limited thereto. The microcontroller unit 106 electrically connects with the data-processing unit 108. The data-processing unit 108 is used to process the data received via the one or more connection interfaces 109. The video and audio data received via the one or more connection interfaces 109 are processed by the data-processing unit 108, and then provided to the audiovisual processing unit 103 via the microcontroller unit 106 for processing and output.

According to an exemplary example shown in the diagram, the audiovisual console 10 and a peripheral device 15 operate different operating platforms with different operating systems. The audiovisual console 10 connects with one or multiple ones of the peripheral device 15 via the connection interface 109. The data-processing unit 108 processes the data transmitted via the connection interface 109. The peripheral device 15 can be a computer device (e.g., a smart phone, a tablet computer, or a personal computer) with powerful audiovisual processing capabilities. The peripheral device 15 can also be a single-purpose peripheral device, such as a camera 17 and a microphone 18 that are respectively disposed with a camera module and an audio-receiving module.

In an exemplary example, as shown in the diagram, the peripheral device 15 connected with the audiovisual console 10 via a Bluetooth communication protocol or a wireless network communication technology is an electronic device that includes a camera module 151, an audio-receiving module 153, and a communication module 155. The peripheral device 15 can be any computer device, such as a smart phone, a tablet computer, or a laptop computer. It should be noted that some essential circuit components (such as a processor, a memory, and related peripherals) are omitted in the schematic diagram. The camera module 151 of the peripheral device 15 includes a lens, a photosensitive element, and an image-processing circuit. The audio-receiving module 153 essentially includes a microphone and an audio-processing circuit. The communication module 155 can be a Bluetooth module, a wireless network (e.g., WiFi™) module, or other wireless communication modules.

The peripheral device 15 can be a commonly used handheld device, such as a smartphone or a tablet computer. Such smart devices generally have multiple microphones that are configured to receive an audio and perform noise reduction, and have multiple cameras to provide photographic functions (which include macro photography, telephoto photography, standard lens photography, and wide-angle photography) through multiple focal lengths. Accordingly, when the collaborative operating system of the audiovisual peripheral devices is in operation, the audiovisual console 10 connects with the peripheral device(s) 15 via the connection interface 109 by a specific communication protocol, and cooperates with a software means for processing the communication protocol. The audiovisual console 10 can therefore receive the video from the peripheral device(s) 15 in a specific format and the audio. After the data-processing unit 108 processes the video and the audio, the microcontroller unit 106 provides the video and the audio to the audiovisual processing unit 103 for performing video and audio encoding/decoding. The video is outputted to the display 12 via the output interface 105 for displaying a picture, and the audio is outputted to the speaker 13 for playing a sound.

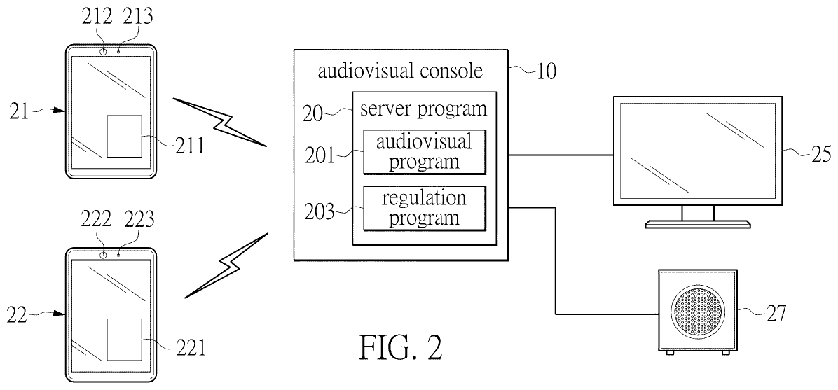

Reference is next made to FIG. 2, which is a schematic diagram illustrating the collaborative operating system of the audiovisual peripheral devices according to one embodiment of the present disclosure.

According to one aspect of operation of the collaborative operating system of the audiovisual peripheral devices, the audiovisual console 10 is configured to operate a server program 20 by the microcontroller unit 106 for processing the video and/or the audio transmitted by one or more peripheral devices. A program can be installed in the microcontroller unit 106 for processing the audiovisual data. For example, an audiovisual program 201 can be a pre-installed audiovisual program in the audiovisual console 10. The audiovisual program 201 can also be installed in the audiovisual console 10 in an over-the-air (OTA) manner.

According to one embodiment of the present disclosure, the audiovisual program 201 can be a commonly seen video conference packaged software or a software program (e.g., a web browser) that performs a Web Real-Time Communication (WebRTC) protocol. In particular, the audiovisual program 201 can be a lightweight program that is only used to process unidirectional audiovisual data (i.e., the audiovisual console 10 only receives the audiovisual data from the peripheral device). The audiovisual console 10 can install and execute a regulation program 203 for regulating the video and the audio. The regulation program 203 can be used to determine positions of one or more microphones (213, 223) and one or more camera lenses (212, 222) of a first peripheral device 21 and a second peripheral device 22, determine a position of a speaker 27 connected with the audiovisual console 10, regulate post-processing (such as power amplification and frequency adjustment) and a volume of a speaker, and regulate brightness and chrominance of the picture displayed on the display 25.

Further, the server program 20 performed in the audiovisual console 10 can be used to process the audiovisual data transmitted from various peripheral devices 21 and 22, and decode the data to be displayed on the display 25. The audio is then played by the speaker 27. Therefore, when a user holds a video conference, the audiovisual console 10 can simultaneously provide the video and the audio for the video conference.

According to certain embodiments of the collaborative operating system of the audiovisual peripheral devices of the present disclosure, the collaborative operating system provides various image and sound sources for the single user to hold the video conference. In FIG. 2, the audiovisual console 10 is capable of connecting with multiple peripheral devices (which include the first peripheral device 21 and the second peripheral device 22). The first peripheral device 21 includes a first camera lens 212 and a first microphone 213. The first peripheral device 21 performs a first audiovisual program 211 to interconnect with the audiovisual program 201 performed in the audiovisual console 10 for transmitting the video captured by the first camera lens 212 and the audio generated by the first microphone 213. The second peripheral device 22 includes a second camera lens 222 and a second microphone 223. The second peripheral device 22 performs a second audiovisual program 221 that is similarly used to interconnect with the audiovisual program 201 performed in the audiovisual console 10 for transmitting the audiovisual data generated by the second camera lens 222 and the second microphone 223.

Thus, the audiovisual console 10 can simultaneously establish connections with the first audiovisual program 211 of the first peripheral device 21 and the second audiovisual program 221 of the second peripheral device 22 by the server program 20, and also obtain a permission for accessing the audiovisual modules (i.e., the cameras and the microphones) of these peripheral devices (i.e., the first peripheral device 21 and the second peripheral device 22). Therefore, the collaborative operating system of the audiovisual peripheral devices allows the user to achieve videoconferencing or audiovisual communications by using various audiovisual sources.

It should be noted that, in the collaborative operating system of the audiovisual peripheral devices, the audiovisual programs (e.g., the first audiovisual program 211 and the second audiovisual program 221) performed in the multiple peripheral devices (e.g., the first peripheral device 21 and the second peripheral device 22) allow the audiovisual console 10 to use the multiple image sources and multiple sound tracks provided by the cameras and microphones of the multiple peripheral devices, so as to achieve the applications of audiovisual communications and videoconferencing. Further, the multiple microphones of the different peripheral devices can collaboratively implement a microphone array.

In another embodiment of the present disclosure, a single peripheral device may be equipped with multiple camera lenses and multiple microphones, and can also be provided for the user to hold the video conference or conduct audiovisual communications when multiple images and sound tracks are required. Taking a smart phone as an example, the smart phone generally includes two to four microphones, in which at least one of the microphones is used for noise reduction, and another one or more of the microphones disposed at the bottom of the smart phone is used for calling. The smart phone may also include one additional microphone disposed on a main camera lens. These microphones on one single smart phone can also implement the microphone array.

Thus, the audiovisual program performed in any of the multiple peripheral devices or in a single peripheral device can receive the audio generated by the microphones at different positions, so as to implement a multi-channel sound source. The multi-channel sound source embodies multi-channel beamforming for tracking a sound source. The beamforming technology can be used to determine a direction of a sound source (e.g., a speaking mouth) according to a time difference between the times of audio signals arriving at different microphones. Accordingly, the beamforming technology allows the audiovisual program 201 performed in the audiovisual console 10 to determine the sound source whilst ignoring the other sound sources.

According to the above-mentioned embodiments of the collaborative operating system of the audiovisual peripheral devices, the audiovisual console 10 can connect with one or more peripheral devices (21 and 22), and can flexibly use one or more cameras and one or more microphones in each of the peripheral devices. The peripheral device (21 or 22) can connect with the audiovisual console 10 in a point-to-point manner. While the peripheral devices (21, 22) transmit the video and the audio to the audiovisual console 10 during the video conference or audiovisual communications, the audiovisual console 10 in another aspect is capable of reversely transmitting data, text, sound, and images to the peripheral devices (21, 22) only based on a same communication protocol (without limiting any connection software installed in the peripheral device).

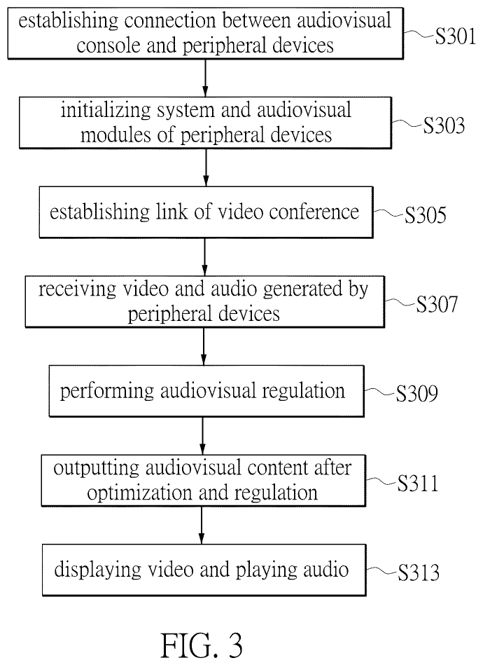

Reference is made to FIG. 3, which is a flowchart illustrating an operating method of the collaborative operating system of the audiovisual peripheral devices according to one embodiment of the present disclosure. When the system is in operation, the audiovisual console and the peripheral device can be within the same location area network or different network domains. The audiovisual console and the peripheral device may operate the same communication protocol that is operated in a video conference program agreed by both parties.

When the audiovisual console and the peripheral device are within a same local area network or a nearby area, the audiovisual console and the peripheral device can be interconnected by a wireless local area network connection or a Bluetooth pairing method. When two corresponding audiovisual programs are respectively activated in the audiovisual console and the peripheral device, the two corresponding audiovisual programs can detect each other and then enable pairing. After the connection between the audiovisual console and the peripheral device is established, the peripheral device executes the video conference program, and establishes a video conference connection with the audiovisual console through an agreed name or number.

When the audiovisual console and the peripheral devices are not within the same local area network, a wide area network (WAN) connection is established. For example, the audiovisual console and the peripheral devices can be connected by an Interactive Connectivity Establishment (ICE) communication protocol or a software program of a Web Real-Time Communication (WebRTC) protocol. When the audiovisual console is powered up, the audiovisual console and the peripheral devices are connected through an agreed name or number after acquiring their respective public IP addresses.

When the corresponding audiovisual programs of the audiovisual console and the peripheral device are activated, the audiovisual programs respectively performed in the audiovisual console and the peripheral device can be mutually detected, so that a connection is established between the audiovisual console and the peripheral device by the above-mentioned method (step S301). In an exemplary example, the body of the audiovisual console can be printed with a barcode (e.g., a QR code) recording its host name and network address, so as to allow the peripheral device to scan the barcode through a camera lens and automatically establish the connection.

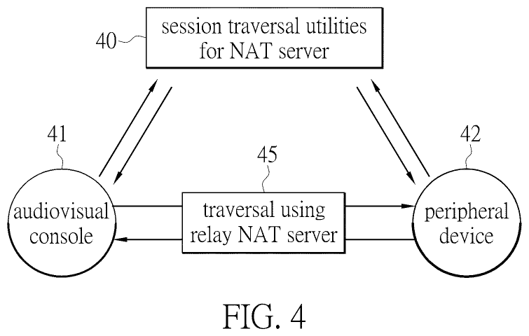

One way of establishing the connection is shown in FIG. 4, which is a schematic diagram illustrating a handshake process between an audiovisual console and a peripheral device according to one embodiment of the present disclosure.

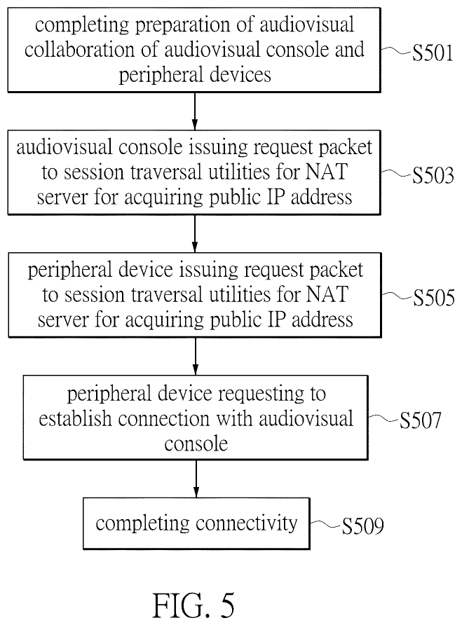

In the diagram, an audiovisual console 41 and a peripheral device 42 are located in different network domains, and each of the devices in different network domains may already be assigned with a private IP address. When the connection between the two devices in different network domains is required to be established, the two devices can send a request to a session traversal utilities for NAT (STUN) server 40 that is configured to perform network address translation (NAT) for acquiring two public IP addresses. Alternatively, the connection can be established via a traversal using relays around NAT (TURN) server 45 that is configured to use relay network address translation. Accordingly, step S301 of FIG. 3 is accomplished, and details thereof are shown in a flowchart of FIG. 5.

Reference is made to FIG. 5, which is the flowchart illustrating a procedure of establishing a conference session between the audiovisual console 41 and the peripheral device 42 through the session traversal utilities for NAT server 40 according to one embodiment of the present disclosure.

In the beginning, both of the audiovisual console 41 and the peripheral device 42 accomplish preparation before the operations of audiovisual collaboration. Before the operations of audiovisual collaboration, the communication protocol or the audiovisual programs should be installed and well configured (step S501). Next, the audiovisual console 41 sends a request packet to the session traversal utilities for NAT server 40 for acquiring a public IP address (step S503). The peripheral device 42 also sends a request packet to the session traversal utilities for NAT server 40 for acquiring another public IP address (step S505). In another aspect, the audiovisual console 41 or the peripheral device 42 can ask the traversal using relays around NAT server 45 for acquiring the public IP address if their connection with the session traversal utilities for NAT server 40 fails.

Afterwards, when both of the audiovisual console 41 and the peripheral device 42 acquire the public IP addresses, the peripheral device 42 requests the audiovisual console 41 to establish a conference session (step S507). After both parties exchange their own public IP addresses via a handshake process, the conference session can be established through the audiovisual programs respectively executed in the audiovisual console 41 and the peripheral device 42 (step S509). In the process of establishing the conference session between the audiovisual console 41 and the peripheral device 42, the audiovisual console 41 can act as a conference console that is used to initiate a conference, and the peripheral device 42 requests the audiovisual console 41 to establish the conference session. Taking a common conference software as an example, the audiovisual console 41 acts as the conference console that can receive a request from one or multiple ones of the peripheral device 42 to establish the conference session. The audiovisual console 41 accordingly initiates an online conference, and provides a conference link or a conference room code that can be represented by a barcode. After the peripheral device 42 scans the barcode or inputs the conference room code, the conference session between the audiovisual console 41 and one or multiple ones of the peripheral device 42 can be established (e.g., step S301 of FIG. 3).

Before the conference session between the audiovisual console and one or more peripheral devices is established (step S501), the audiovisual console (as shown in the embodiment of FIG. 1) performs the server program for managing user accounts. In a specific application, the user (having user identification data) needs to log in the audiovisual console, and the peripheral device can be the user's own smart device in which the user account is already logged in. The audiovisual programs respectively executed in the audiovisual console and the peripheral device can establish the conference session based on the same user identification data. Under authorization of the user (e.g., obtaining the authorization through specific identification data), the audiovisual console can obtain the permission for accessing the camera and the microphone of the peripheral device.

For example, the peripheral device is the user's mobile device, and the user logs in the audiovisual program (e.g., the first audiovisual program 211 and the second audiovisual program 221 of FIG. 2) executed in the mobile device with the user identification data (a user ID). On the other hand, the user can log in the server program (e.g., the server program 20 of FIG. 2) executed in the audiovisual console with the same user identification data. After that, a connection is established between the audiovisual program executed in the mobile device and the server program executed in the audiovisual console. Since both of the audiovisual console and the mobile device use the same user identification data, the audiovisual console can obtain the permission for accessing the audiovisual module (i.e., the one or more cameras and/or one or more microphones) of the mobile device, and the audiovisual console can successfully obtain the audiovisual data generated by the mobile device. On the other hand, in another aspect, the audiovisual console can also reversely transmit signals, data, text, sound, and/or images to the mobile device via the connection established there-between.

Next, in step S303 of FIG. 3, the server program executed in the audiovisual console receives the signals generated by the peripheral device via the connection, and also detects the audiovisual module of the peripheral device. The audiovisual module can be one or more cameras and one or more microphones. Through the user authorization, the audiovisual console obtains the permission for accessing the audiovisual module of the peripheral device, and initializes the system and the audiovisual module of the peripheral device (step S303).

In the meantime, as shown in step S305 of FIG. 3, the audiovisual communication or the video conference can be held over the conference session. The audiovisual console starts to receive the video and the audio generated by the peripheral device (step S307). A regulation program can be used to regulate the video and the audio (step S309). When the video and the audio are processed by the data-processing unit of the audiovisual console, the microcontroller unit generates the audiovisual data provided to the audiovisual processing unit of the audiovisual console. After the audiovisual processing unit processes the audiovisual data, a regulated and optimized audiovisual content is outputted via an output interface (step S311). At this time, the video conference is activated based on the regulation. The display connected with the audiovisual console displays the video, and the speaker connected with the audiovisual console plays the audio (step S313) until the video conference ends.

Taking a multi-user video conference as an example, the user uses the audiovisual console and one or more peripheral devices to form a first conference terminal, and the first conference terminal establishes a conference session with a second conference terminal through a specific conference console. The user can use a common conference system or a conference terminal implemented by the collaborative operating system of the audiovisual peripheral devices of the present disclosure. Thus, the first conference terminal uses the display connected with the audiovisual console to display the video received from at least one of the peripheral devices, and uses the speaker to play the audio received from the at least one of the peripheral devices, so as to hold the video conference with the second conference terminal or many more conference terminals.

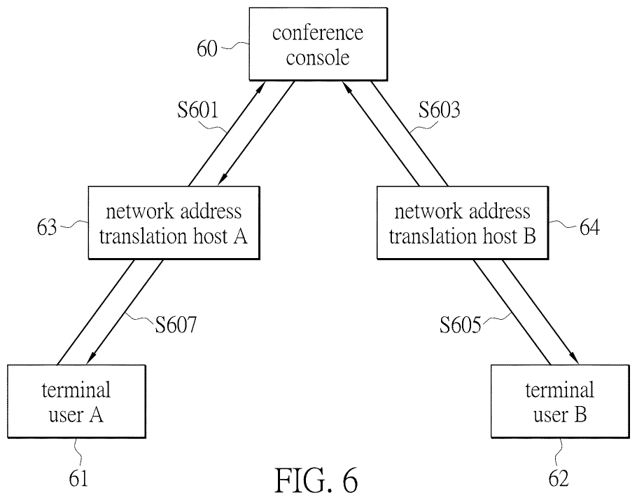

Reference is made to FIG. 6, which is a flowchart illustrating a process of establishing a connection by a network address translation host according to one embodiment of the present disclosure. A conference console 60 is used to provide a service of multi-party conference session, and can be used to manage user authentication and establishment of a conference session. The users can each be within a specific local area network, and a mechanism of network address translation (NAT) is required to transfer the private IP address into the public IP address. The above-mentioned Web Real-Time Communication (WebRTC) protocol can be used to establish the conference session.

For example, a terminal user A 61 and/or a terminal user B 62 (as shown in FIG. 6) can be the conference terminal that is implemented by the collaborative operating system of the audiovisual peripheral devices. The terminal user A 61 is located in a network domain and assigned with a private IP address. A network address translation host A 63 transfers the private IP address into a public IP address. Similarly, another private IP address assigned to the terminal user B 62 can also be transferred to a public IP address by a network address translation host B 64.

When a conference session is being established, the terminal user A 61 can send a request to the conference console 60 for establishing a connection with the terminal user B 62 (step S601). The connection request submitted to the conference console 60 includes information of the terminal user A 61. The information submitted to the conference console 60 includes a session description protocol (SDP). The conference console 60 then transmits the connection request submitted by the terminal user A 61 and the session description protocol to the terminal user B 62 (step S603). When the terminal user B 62 receives the connection request and the session description protocol from the terminal user A 61, the terminal user B 62 responds to the session description protocol (step S605). The terminal user B 62 also transmits its information and session description protocol to the conference console 60, and the conference console 60 forwards the session description protocol of the terminal user B 62 to the terminal user A 61 (step S607). Thus, the terminal user A 61 and the terminal user B 62 can have connection information of one another, so that a point-to-point conference session is established. Furthermore, both of the terminal user A 61 and the terminal user B 62 use the interactive connectivity establishment (ICE) communication protocol or the Web Real-Time Communication (WebRTC) protocol to proceed with the subsequent communications, which include transmitting an audiovisual content under an agreed communication protocol.

It should be noted that, through the above-described connection process, the point-to-point connection between the terminal user A 61 and the terminal user B 62 can be established. If the connection fails, the traversal using relays around NAT (TURN) server can be used as a backup connection.

The collaborative operating system of the audiovisual peripheral devices provides a solution that allows the audiovisual console without audiovisual peripherals to utilize the audiovisual modules (such as a camera module and an audio-receiving module) of the peripheral device. The peripheral device utilized by the audiovisual console can include multiple audio-receiving modules. Alternatively, the audiovisual console can simultaneously operate with multiple peripheral devices, so as to obtain a permission for accessing multiple audio-receiving modules of the multiple peripheral devices. Accordingly, a multi-channel sound application of the collaborative operating system can be implemented.

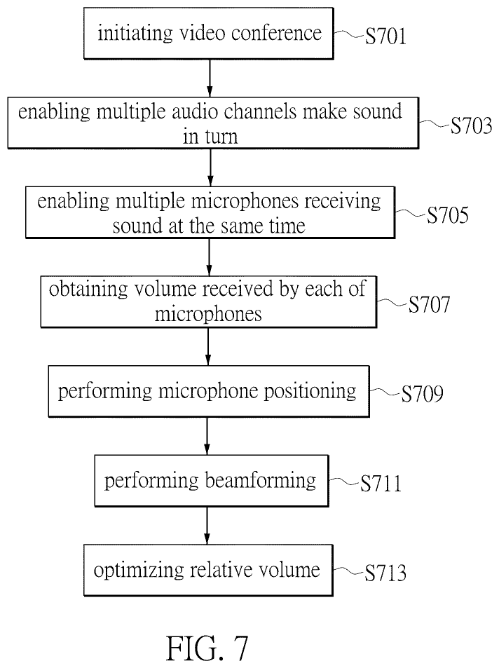

Reference is made to FIG. 7, which is a flowchart illustrating application of multiple audio channels of the collaborative operating system of the audiovisual peripheral devices according to one embodiment of the present disclosure.

When the audiovisual console successfully connects with one or more peripheral devices, the audiovisual console obtains the permission for accessing the audiovisual modules of the one or more peripheral devices and initiates a video conference (step S701). At this time, a regulation procedure is activated. The audiovisual program executed in the audiovisual console uses the speaker connected with the audiovisual console to make sounds in turn via the multiple audio channels (step S703). For example, the audiovisual console connects with a 5.1-channel surround sound system that controls each of the multiple audio channels to make sounds in turn.

The audiovisual console controls operations of the audio-receiving modules of the one or more peripheral devices. Each of the multiple microphones is assigned with a microphone ID. The multiple microphones receive the sounds generated by the surround sound system (step S705). The microcontroller of the audiovisual console receives sounds from each of the multiple microphones (step S707), and performs positioning on each microphone according to audio magnitude of each of the microphones (step S709).

Beamforming can be performed on audios received from a multi-channel sound source (step S711). Through the operation of the microcontroller of the audiovisual console, the position of the sound source can be determined according to the time differences between the times of the audios arriving at different microphones. Therefore, the sound can be optimized based on the position of the sound source (step S713). For example, the audiovisual console positions each of the speakers according to the audio signals received from the audio-receiving module. The positions of the speakers and the microphones can be calibrated by repeating the above process, so that the audiovisual console can provide better sound effects. In one of the applications, when the user attends a video conference, the positions, orientations, and gains of the multiple microphones can be adjusted according to a location of the user (which can be determined through an image-processing process).

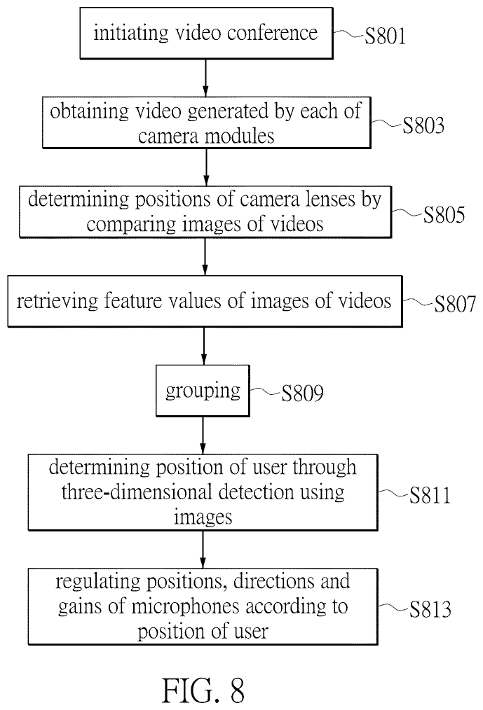

FIG. 8 is a flowchart illustrating application of multiple cameras of the collaborative operating system of the audiovisual peripheral devices according to one embodiment of the present disclosure.

When the audiovisual console connected with multiple cameras initiates a video conference (step S801), the video conference can display the images captured by the multiple cameras in turn. In an aspect, the microcontroller of the audiovisual console receives videos generated by each of the camera modules (step S803). An image-processing technology is used to compare the images of each of the videos for determining positions of the camera lenses (step S805). In an exemplary example, an algorithm executed in the microcontroller unit retrieves image information and normalizes the images (e.g., enlarging or reducing the images to be a same size). The images with the same size are beneficial for obtaining differences and similarities of the images captured through each of the camera lenses, so that the positions of the camera lenses can be determined. For example, a front lens and a rear lens of a smart phone can be determined, and a wide-angle lens and a telephoto lens can also be determined.

The microcontroller of the audiovisual console can retrieve feature values of the images of the video (step S807), and group the images of the videos captured by the multiple cameras based on the image features (step S809). For example, when a shooting direction of each of the camera lenses of a smart phone is obtained, the camera lenses can be divided into a front lens and a rear lens. The audiovisual console performs three-dimensional detection on the multiple images that are obtained at the same time, and analyzes the images for determining the location of the user who attends the video conference (step S811). Before or during the video conference, the microphones can be regulated based on the location of the user. Therefore, a position, a direction, and a gain of each of the microphones can be regulated (step S813).

According to certain embodiments of the present disclosure, when the user only uses a single camera to attend the video conference, the images obtained by the audiovisual console can be analyzed for obtaining ambient brightness, and the brightness of the images captured by the camera can be regulated. On the other hand, when two or more cameras are adopted in the video conference, the audiovisual console can rely on the images captured by the cameras to perform three-dimensional detection, so as to determine relative distances of each item in one place. Accordingly, an error that occurs when the beamforming process is performed on the audios generated by the microphones can be corrected. For example, an image-recognition technology that can be an artificial intelligence module is used to accurately recognize an orientation of a speaker, so that a sound field can be more precisely regulated. Further, if the camera cannot determine a depth of field, the audiovisual console can drive the speakers to generate audios, and use the microphones to receive the audios. The time differences between the times of the audio signals arriving at different microphones can be computed, so as to infer the positions of the microphones. Accordingly, the collaborative operating system of the audiovisual peripheral devices can rely on the audios received by the multiple microphones (which are connected with the audiovisual console) and the images captured through the multiple camera lenses (which are connected with the audiovisual console) to detect the place where the video conference is held. In addition, the microphones and the cameras can be mutually calibrated.

In conclusion, according to the above embodiments of the collaborative operating system of the audiovisual peripheral devices and the operating method provided by the present disclosure, the system allows the audiovisual console without installation of any camera or microphone or the audiovisual console that needs to be expanded with more microphones and cameras to utilize the audiovisual module of a peripheral device, so as to hold a video conference. The audiovisual console and the peripheral device are connected via a cross-platform communication technology, so that the audiovisual console is capable of providing an optimized audiovisual service without additional costs for the peripherals. Furthermore, compared with a conventional device having fixed camera lenses and microphones, the collaborative operating system of the audiovisual peripheral devices and the operating method of the present disclosure can provide a more flexible and scalable solution.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A collaborative operating system of audiovisual peripheral devices, comprising:
an audiovisual console, wherein the audiovisual console includes an audiovisual processing unit, a microcontroller used to operate collaboration of audiovisual peripherals, at least one connection interface, and a data-processing unit used to process data transmitted via the at least one connection interface;
wherein the audiovisual console connects with at least one peripheral device via the at least one connection interface based on a communication protocol, and detects one or more cameras and one or more microphones of the at least one peripheral device;
wherein, after a permission for accessing the one or more cameras and the one or more microphones is obtained, the audiovisual console receives a video and an audio from the at least one peripheral device via the at least one connection interface based on the communication protocol; wherein, after the data-processing unit processes the video and the audio, the microcontroller generates audiovisual data provided to the audiovisual processing unit; wherein, after the audiovisual processing unit processes the audiovisual data, the audiovisual console uses a display to display the video, and uses a speaker to play the audio.

2. The collaborative operating system according to claim 1, wherein, when the audiovisual console and the at least one peripheral device are located within a same local area network or a same area, the audiovisual console and the at least one peripheral device are interconnected by a wireless local area network or a Bluetooth communication protocol.

3. The collaborative operating system according to claim 1, wherein, when the audiovisual console and the at least one peripheral device are not located within a same local area network, a connection between the audiovisual console and the at least one peripheral device is established by a software program running an Interactive Connectivity Establishment (ICE) communication protocol or a Web Real-Time Communication (WebRTC) protocol.

4. The collaborative operating system according to claim 1, wherein the at least one connection interface is a wireless or wired communication interface that is used to receive the video captured through lenses of the multiple cameras and the audio received by the multiple microphones of the at least one peripheral device.

5. The collaborative operating system according to claim 4, wherein the multiple microphones form a microphone array, so as to receive the audio from the microphones at different positions and perform multi-channel beamforming for tracking a sound source.

6. The collaborative operating system according to claim 5, wherein the microcontroller of the audiovisual console obtains information of a volume of each of the microphones, and performs positioning on the multiple microphones according to audio magnitude of each of the microphones.

7. The collaborative operating system according to claim 6, wherein, after the positioning of the multiple microphones is completed, positions, orientations, and gains of the multiple microphones are adjusted according to a location of a user.

8. The collaborative operating system according to claim 4, wherein the microcontroller retrieves images captured through the lenses of the cameras, and an image-processing technology is used to compare the images of the video captured through each of the lenses, so as to determine a position of each of the cameras.

9. The collaborative operating system according to claim 8, wherein, in the audiovisual console, a location of a user is determined by performing three-dimensional detection on the multiple images captured through the lenses of the multiple cameras.

10. The collaborative operating system according to claim 1, wherein a user uses identification data to log in a server program of the audiovisual console and an audiovisual program of the at least one peripheral device, so that a connection is established between the audiovisual console and the at least one peripheral device, and the audiovisual console obtains the permission for accessing the one or more cameras and the one or more microphones of the at least one peripheral device.

11. The collaborative operating system according to claim 10, wherein the audiovisual console executes a video conference program or a software program of a Web Real-Time Communication (WebRTC) protocol.

12. The collaborative operating system according to claim 10, wherein the audiovisual console includes a regulation program that is used to regulate the video and the audio, determine positions of the one or more microphones and the one or more cameras of the at least one peripheral device, determine a position of the speaker connected with the audiovisual console, regulate post-processing and a volume of the speaker, and regulate brightness and chrominance of a picture displayed on the display.

13. The collaborative operating system according to claim 1, wherein the audiovisual console and the at least one peripheral device form a first conference terminal, and the first conference terminal is configured to connect with a second conference terminal, so as to establish a conference session; wherein the audiovisual console of the first conference terminal uses the display to display the video received from the at least one peripheral device, and uses the speaker to play the audio received from the at least one peripheral device, so that a video conference is in operation.

14. An operating method of a collaborative operating system of audiovisual peripheral devices, which is operated in an audiovisual console, the operating method comprising:
connecting the audiovisual console to at least one peripheral device via at least one connection interface of the audiovisual console based on a communication protocol, and detecting one or more cameras and one or more microphones of the at least one peripheral device;
obtaining a permission for accessing the one or more cameras and the one or more microphones, and receiving, by the audiovisual console, a video and an audio from the at least one peripheral device via the at least one connection interface based on the communication protocol; and
generating, by a microcontroller of the audiovisual console, audiovisual data provided to an audiovisual processing unit of the audiovisual console, and displaying the video by a display connected with the audiovisual console and playing the audio by a speaker after the audiovisual data is processed by the audiovisual processing unit.

15. The operating method according to claim 14, wherein the multiple microphones form a microphone array, so as to receive the audio from the microphones at different positions and perform multi-channel beamforming for tracking a sound source; wherein, when the microcontroller of the audiovisual console obtains information of a volume of each of the microphones, the microcontroller performs positioning on the multiple microphones according to audio magnitude of each of the microphones.

16. The operating method according to claim 15, wherein, after the positioning of the multiple microphones is completed, positions, orientations and gains of the multiple microphones are adjusted according to a location of a user.

17. The operating method according to claim 14, wherein the microcontroller retrieves images captured through the lenses of the cameras, and an image-processing technology is used to compare the images of the video captured through each of the lenses, so as to determine a position of each of the cameras.

18. The operating method according to claim 17, wherein, in the audiovisual console, a location of a user is determined by performing three-dimensional detection on the multiple images captured through the lenses of the multiple cameras.

19. The operating method according to claim 14, wherein a user uses identification data to log in a server program of the audiovisual console and an audiovisual program of the at least one peripheral device, so that a connection is established between the audiovisual console and the at least one peripheral device, and the audiovisual console obtains the permission for accessing the one or more cameras and the one or more microphones of the at least one peripheral device.

20. The operating method according to claim 14, wherein the audiovisual console and the at least one peripheral device form a first conference terminal, and the first conference terminal is configured to connect with a second conference terminal so as to establish a conference session; wherein the audiovisual console of the first conference terminal uses the display to display the video received from the at least one peripheral device and use the speaker to play the audio received from the at least one peripheral device, so that a video conference is in operation.
